(19) United States
(12) Patent Application Publication
(10) Pub. No.: US 2007/0126833 A1
(43) Pub. Date: Jun. 7, 2007

(54) Digital printing using ultraviolet inks

(76) Inventors: Michael M. Laurin, Pittsfield, MA (US); Richard E. Malthouse, Hudson, OH (US); Charlie W. Wood, Peru, MA (US); Kiam Peng Yeo, Old Chatham, NY (US)

Correspondence Address: GEAM - 08CS - STRUCTURED PRODUCTS;IP LEGAL, ONE PLASTICS AVENUE, PITTSFIELD, MA, 01201-3697, US

(21) Appl. No.: 11/294,948

(22) Filed: Dec. 6, 2005

(51) Int. Cl. B41J 2/01

(52) U.S. Cl. 347/102; 347/100

(57) ABSTRACT

The present invention relates to methods for digitally printing images onto a substrate such as polycarbonate, without the use of coatings, etc. to promote adhesion, and permits direct printing of a UV ink system onto the substrate, without the use of a pretreatment step. The invention allows for ease of incorporation of intricate photographic quality images onto a substrate, and can allow a processor to print multiple images on a single piece of material. The processor can then readily change the images from one part to the next and can incorporate changes such as languages, graphics, backgrounds, foregrounds, etc. without having to alter screens, as in the screen-printing process. Thus, a part manufacturer may individualize each part as it is made in a “just in time” process.

### FIELD OF THE INVENTION

The present invention relates to methods for digitally printing images onto a substrate, without the use of coatings to promote adhesion, and permits direct printing of a UV ink system onto the substrate, without the use of a pretreatment step.

### BACKGROUND OF THE INVENTION

Polymeric sheets and laminates are commonly printed with full color, decorative print patterns. The printed sheets or laminates can be bonded to an injection molded substrate to make the finished part, or used on their own as labels or signage. These products can include interior automotive parts such as dashboard parts and gauges with decorative finishes, including decorative wood grain, and other products such as cell phones, personal electronic equipment (MP3 and CD players), EMI/RFI shielding, signs, and outdoor siding panels, for example. These products are commonly made by screen printing using multiple screens to separate colors, or a gravure printing process in which color separations in individual layers are initially sent to an engraver and produced on gravure plates.

Inks are produced for individual color layers, and a composite is made to duplicate the customer's color sample. When the colors are acceptable, these steps are repeated to produce production gravure cylinders. The composite is then color-matched on a gravure press, and when the color match is acceptable, the gravure cylinders print the finished pattern. The substrate can comprise a polymeric sheet printed with several passes through the gravure press to produce the various color elements of the finished design. The sheet then can be laminated to a substrate, and thermoformed and/or injection molded to a finished three-dimensional shape.

Digital printing allows use of computer generated and enhanced images. This can provide substantial design and production advantages over gravure and screen printing. Computer generated images can be stored and instantly produced from computer memory. This also allows multiple designs to be printed at the same time, whereas with gravure printing, each separate design print must be made in the multi-step process described above.

Current ultraviolet (UV) ink technology used in digital ink jet and offset printing is characterized by difficulties in bonding of ink to polymeric based webs (e.g., polycarbonate), without the use of pretreatment layers. The pretreatment of a polycarbonate film, in turn, significantly increases the cost of the finished product. The state of the art is comprised of ink jet printing with the use of some type of coating on the substrate to promote adhesion, using transfer or thermal transfer printing techniques, incorporating cellulose esters into the material to promote printability, and solvent based ink systems. The preparation of printable articles for ink jet printers involves coating the substrate with a composition comprising, e.g., a cross linkable amine functional polymer and blocked polyfunctional isocyanate; and heating to produce a cross linked ink receptive layer. This method requires that a coating be placed the polycarbonate, so that the ink will bond to it.

The transfer of film for the formation of an image on a substrate, e.g. a data-carrying carrying device, comprises forming the image into a carrier substrate that has been coated with a receptive layer having a transferable skin layer and absorptive layer. This method uses transfer technology, where an image is placed on a carrier substrate and is then transferred to a second substrate with heat and pressure.

An alternative method includes the printing of plastic films with organic inks in an ink jet process. The film contains a film-forming plastic and usual auxiliary materials, as well as cellulose esters which improve printability. This method involves adding cellulose esters to the substrate to enhance printability.

In WO03020529A1, a flexible, thermoformable polymeric based web is placed in an ink jet printer, and a solvent-based (non-aqueous) digital printing ink is applied directly to the base web. This method describes ink jet printing with solvent inks, but not UV inks, the latter inks providing potential environmental advantages.

The use of actinic radiation, such as UV radiation, to cure ink compositions is generally known in the art. UV radiation can be used to cure various types of inks, such as thiolene inks, inks made up of aryl diazonium salts and epoxy resins, and inks containing acrylates, including acrylated epoxies and urethanes. Of these, acrylate containing inks are often preferred because they are available at a reasonable cost and have good storage stability, in addition to their useful properties as inks.

Acrylate-type UV curable inks are typically made up of a pigment dispersed in a reactive base that may contain photoinitiators, reactive monomers or oligomers, preservatives, flow agents, etc. The properties of the ink such as viscosity, gloss, and crosslink density can be controlled by varying the types and/or proportions of reactive diluents used in the formulation.

The present invention relates to the use of an ink cured or hardened by UV radiation that is suitable for direct decoration of substrates such as, for example, polycarbonate, textured polycarbonate, coated polycarbonate, blends of polycarbonate, vinyls, and polyesters. Specifically, this invention concerns a UV ink and ink jet process suitable for printing black, white, or colored photographic quality images on these substrates. An objective of the present invention is to provide a UV ink for decoration by ink jet printing of substrates, such as polycarbonate.

### SUMMARY OF THE INVENTION

The present invention relates to methods for digitally printing images onto a substrate such as polycarbonate, without the use of coatings, etc. to promote adhesion, and permits direct printing of a UV ink system onto the substrate, without the use of a pretreatment step. The invention allows for ease of incorporation of intricate photographic quality images onto a substrate, and can allow a processor to print multiple images on a single piece of material. The processor can then readily change the images from one part to the next and can incorporate changes such as languages, graphics, backgrounds, foregrounds, etc. without having to alter screens, as in the screen-printing process. Thus, a part manufacturer may individualize each part as it is made in a “just in time” process.

### DESCRIPTION OF THE PREFERRED EMBODIMENTS

In accordance with the present invention, there is provided a UV ink comprising an alkylene glycol acrylate material, for digital decoration of substrates such as polycarbonate. In a preferred embodiment, the ink comprises a mole % mixture of about 57-67% dipropylene glycol diacrylate, about 14-24% polyethylene glycol diacrylate, about 0.1-10% alkyl monoacrylate, and about 9-19% photoinitiators, with a mole % mixture of about 62% dipropylene glycol diacrylate, about 19% polyethylene glycol diacrylate, about 5% alkyl monoacrylate, and about 14% photoinitiators being particularly preferred, and tested as discussed below. The dipropylene glycol diacrylate is preferably a difunctional acrylate monomer that is used in UV-curable formulations where low viscosity is important, such as in ink jet printing. Preferably, the oligomeric glycol diacrylates have a maximum glycol chain length of about 4 or 5, and as such are not considered to be oligomers by the UV-curable coatings industry, because these monomers do not impart significant viscosity to the formulation.

An isooctyl acrylate monomer is preferably a reactive diluent in the formulation. Photoinitiators such as hydroxycyclohexyl-phenylketone and dimethoxy-diphenylethanonie are preferably used to absorb at shorter wavelengths, and provide surface cure. Additional photoinitiators, such as methyl-(methylthio)phenyl-morpholinyl-propanone, and benzyl-(demethylamino)-(morpholinyl)phenyl-butanone are also preferably used to absorb strongly in the longer wavelength UV region, and provide through cure in the pigmented systems.

The following components may also be added to the ink: pigments, extenders, surfactants, stabilizers, deodorants, biocides, identifying tracers, defoamers, flow aids, or other film forming resins such as, e.g., polyesters or acrylics. Note that components having a deleterious effect on the desirable properties of the ink should, of course, not be incorporated in the ink. One such component is a silicone flow aid, which can reduce adhesion.

In accordance with the present invention, there is provided a set of preferable process parameters for printing the aforementioned ink onto, for example, a polycarbonate substrate using an ink jet printer. Preferably, the temperature of the ink inside the ink jet printer print head should be maintained at about 45 to 55° C. In the testing of the present invention, this temperature was controlled through the water heater in the print head.

The ink droplet size in picoliters (pl) that provides the best results in terms of bond and image quality preferably ranges from about 6 pl to 42 pl. Note that it is possible to employ any size droplet such as 6 pl, 12 pl, 18 pl, 24 pl, 30 pl, 36 pl, and 42 pl in order to achieve a good bond and high quality image. Note also that the diameter of the orifice in the print head is preferably equal to the ink droplet size.

In experiments, the following ink droplet sizes and orifice diameters were used to obtain the appropriate resolutions:

| Resolution | | |
|---|---|---|
| (dots per inch) | Ink Droplet size (pl) | Diameter of Orifice (pl) |
| 300 | 12, 24, 42 | 12, 24, 42 |
| 600 | 6, 12, 24 | 6, 12, 24 |
| 1200 | 6 | 6 |
| 2400 | 6 | 6 |

The substrate (e.g., polycarbonate) should have a surface tension of about 30 to 46 dynes, and a surface energy of about 32 to 45 dynes/cm. The surface should be free of any residues, for instance, those that may arise from polyethylene masking. If masking is to be used, it is preferable to utilize a masking that does not leave a residue, such as polyester. If a residue has been left by a masking, it is possible to clean the substrate with e.g., water or isopropyl alcohol prior to printing, so as to obtain maximum ink adhesion during printing.

In accordance with the present invention, curing with actinic radiation takes place using UV radiation. Such curing is carried out using customary and known radiation sources. Examples of suitable radiation sources are high or low pressure mercury vapor lamps. The ink jet printer (Mimaki UJF605C) used in the testing of the present invention incorporates a flash lamp that instantly cures and dries the ink during the printing process.

Experiments and Discussion

Experiment 1: A polished polycarbonate substrate of uniform thickness (0.010 inch) and with protective polyethylene masking on both sides was prepared for printing, by removing the protective mask. The surface tension of the polycarbonate was 38 to 40 dynes, and the surface energy measured 34 dynes/cm. This sample was printed using a Mimaki UJF605C UV ink jet printer using inks and processing as described above, and at the various resolutions as described above. After printing, a cross hatch test was performed; the result was 0-B adhesion, which constituted a failure. Note that cross hatch adhesion of inks is commonly measured as 0-B, 1-B, 2-B, 3-B, 4-B, or 5-B, the rating dependent on the amount of ink removed after cross hatching (i.e., cutting a grid through the ink and into the substrate), taping over the cross hatched area, and quickly tearing the tape away. If all of the ink is removed, the result is 0-B adhesion.

Experiment 2: A polished polycarbonate substrate of uniform thickness (0.010 inch) and with protective polyethylene masking on both sides was prepared for printing by removing the protective mask and cleaning the surface with isopropyl alcohol (IPA). The surface tension of the polycarbonate was 38 to 40 dynes, and the surface energy measured 34 dynes/cm. This sample was printed using a Mimaki UJF605C UV ink jet printer using inks and processing as described above, and at the various resolutions as described above. After printing, a cross hatch test was performed; the result was 5-B adhesion (no ink was removed), which constituted excellent adhesion and a pass.

Experiment 2 was repeated replacing the IPA with water (Experiment 3). The result was 5-B adhesion (no ink was removed), which constituted excellent adhesion and a pass. Experiment 2 was then repeated, replacing the IPA with wiping the surface with a clean dry cloth (Experiment 4). The result was 5-B adhesion (no ink was removed), which constituted excellent adhesion and a pass.

Experiment 5: A polished polycarbonate substrate of uniform thickness (0.01 0 inch) and with protective polyethylene masking on one side was prepared for printing, by placing the substrate on the machine with the unmasked side toward the print heads. The surface tension of the polycarbonate was 38 to 40 dynes, and the surface energy measured 34 dynes/cm. This sample was printed using a Mimaki UJF605C UV ink jet printer using inks and processing as described above and at the various resolutions as described above. After printing, a cross hatch test was performed; the result was 0-B adhesion (all ink was removed), which constituted a failure.

Experiment 5 was repeated with the addition of cleaning the surface of the polycarbonate with IPA (Experiment 6). The result was 5-B adhesion (no ink was removed), which constituted excellent adhesion and a pass. Experiment 5 was repeated with the addition of cleaning the surface of the polycarbonate with water (Experiment 7). The result was 5-B adhesion (no ink was removed), which constituted excellent adhesion and a pass. Experiment 5 was then repeated with the addition of cleaning the surface of the polycarbonate with a clean dry cloth (Experiment 8). The result was 5-B adhesion (no ink was removed), which constituted excellent adhesion and a pass.

Experiment 9: A textured polycarbonate substrate of uniform thickness (0.010 inch) and without any protective polyethylene masking was prepared for printing, by placing the substrate on the machine with the textured side toward the print heads. The surface tension of the polycarbonate was greater than 44 dynes, and the surface energy measured 37 dynes/cm. This sample was printed using a Mimaki UJF605C UV ink jet printer using inks and processing as described above, and at the various resolutions as described above. After printing, a cross hatch test was performed; the result was 5-B adhesion (no ink was removed), which constituted excellent adhesion and a pass.

Experiment 10: A sample of polycarbonate substrate of uniform thickness (0.020 inch) and coated with an anti-fog coating (as described in U.S. Pat. No. 5,877,254) and with a protective polyester masking over the coating was prepared for printing, by removing the polyester masking from the coated surface and placing the substrate on the machine with the coated side toward the print heads. The surface tension of the coated polycarbonate was 32 to 34 dynes, and the surface energy measured 45 dynes/cm. This sample was printed using a Mimaki UJF605C UV ink jet printer using inks and processing as described above, and at the various resolutions as described above. After printing, a cross hatch test was performed; the result was 5-B adhesion (no ink was removed), which constituted excellent adhesion and a pass.

Experiment 11: A polished polyester substrate of uniform thickness (0.004 inch) was prepared for printing, by placing the substrate on the machine. This sample was printed using a Mimaki UJF605C UV ink jet printer using inks and processing as described above, and at the various resolutions as described above. After printing, a cross hatch test was performed; the result was 5-B adhesion (no ink was removed), which constituted excellent adhesion and a pass.

Experiment 12: A polished vinyl substrate of uniform thickness (0.010 inch) was prepared for printing, by placing the substrate on the machine. This sample was printed using a Mimaki UJF605C UV ink jet printer using inks and processing as described above, and at the various resolutions as described above. After printing, a cross hatch test was performed and the result was 5-B adhesion (no ink was removed), which constituted excellent adhesion and a pass.

Experiment 13: A textured vinyl substrate of uniform thickness (0.010 inch) was prepared for printing by placing the substrate on the machine. This sample was printed using a Mimaki UJF605C UV ink jet printer using inks and processing as described above, and at the various resolutions as described above. After printing, a cross hatch test was performed; the result was 5-B adhesion (no ink was removed), which constituted excellent adhesion and a pass.

While the present invention has been described with respect to particular embodiment thereof, it is apparent that numerous other forms and modifications of the invention will be obvious to those skilled in the art. The appended claims and this invention generally should be construed to cover all such obvious forms and modifications, which are within the true spirit and scope of the present invention.

We claim:

1. A method for digitally printing images onto a substrate, comprising passing the substrate through a printer which applies an ultraviolet-cured ink directly onto the substrate, the ink including an alkylene glycol acrylate material.

2. The method as recited in claim 1, wherein the substrate is selected from the group consisting of polycarbonate, textured polycarbonate, coated polycarbonate, blends of polycarbonate, vinyls, and polyesters.

3. The method as recited in claim 1, wherein the printer is an ink jet printer.

4. The method as recited in claim 3, wherein the temperature of the ink inside the ink jet printer is about 45 to 55° C.

5. The method as applied in claim 1, wherein the ink is applied in the absence of a pretreatment layer.

6. The method as recited in claim 1, wherein the alkylene glycol acrylate material comprises oligomeric glycol diacrylates, in combination with an alkyl monoacrylate.

7. The method as recited in claim 6, wherein the oligomeric glycol diacrylates comprise a combination of a dipropylene glycol diacrylate and a polyethylene glycol diacrylate.

8. The method as recited in claim 1, wherein the ink further comprises a photoinitiator.

9. The method as recited in claim 1, wherein the droplet size of the ink is from about 6 to 42 picoliters.

10. The method as recited in claim 6, wherein the oligomeric glycol diacrylates have a maximum glycol chain length of about 4-5.

11. The method as recited in claim 8, wherein the photoinitiator is selected from the group consisting of hydroxycyclohexyl-phenylketone, dimethoxy-diphenylethanone, methyl-(methylthio) phenyl-morpholinyl-propanone, and benzyl-(dimethylamino)-(morpholinyl)phenyl-butanone.

12. A digitally printed substrate, produced by a process comprising passing the substrate through a printer which applies an ultraviolet-cured ink directly onto the substrate, the ink including an alkylene glycol acrylate material.

13. The digitally printed substrate as recited in claim 12, wherein the substrate is selected from the group consisting of polycarbonate, textured polycarbonate, coated polycarbonate, blends of polycarbonate, vinyls, and polyesters.

14. The digitally printed substrate as recited in claim 12, wherein the printer is an ink jet printer.

15. The digitally printed substrate as recited in claim 14, wherein the temperature of the ink inside the ink jet printer is about 45 to 55° C.

16. The digitally printed substrate as applied in claim 12, wherein the ink is applied in the absence of a pretreatment layer.

17. The digitally printed substrate as recited in claim 12, wherein the alkylene glycol acrylate material comprises oligomeric glycol diacrylates, in combination with an alkyl monoacrylate.

18. The digitally printed substrate as recited in claim 12, wherein the droplet size of the ink is from about 6 to 42 picoliters.

19. The digitally printed substrate as recited in claim 17, wherein the oligomeric glycol diacrylates have a maximum glycol chain length of about 4-5.

20. The digitally printed substrate as recited in claim 12, wherein the ink further comprises a photoinitiator selected from the group consisting of hydroxycyclohexyl-phenylketone, dimethoxy-diphenylethanone, methyl-(methylthio)phenyl-morpholinyl-propanone, and benzyl-(dimethylamino)-(morpholinyl)phenyl-butanone.
